(19) United States
(12) Patent Application Publication
(10) Pub. No.: US 2005/0086689 A1
(43) Pub. Date: Apr. 21, 2005

(54) Interactive program guides providing program segment information

(75) Inventors: Gil Gavriel Dudkiewicz, San Francisco, CA (US); Dale Kittrick Hitt, San Jose, CA (US)

Correspondence Address: FOLEY & LARDNER, 2029 CENTURY PARK EAST, SUITE 3500, LOS ANGELES, CA, 90067, US

(73) Assignee: MyDTV, Inc.

(21) Appl. No.: 10/687,984

(22) Filed: Oct. 17, 2003

(51) Int. Cl. G06F 3/00; H04N 5/445

(52) U.S. Cl. 725/40; 725/44; 725/38; 348/563

(57) ABSTRACT

Interactive program guides and interactive program banners are enhanced through the use of individual program segment metadata that provides descriptive and timing information for individual segments of television programs. The program guides and program banners provide detailed information to the viewer about individual program segments, such as descriptions of individual segments, the time and duration of individual segments, and the location of individual segments within the program. Viewer preferences may be updated and future programs and segments may be searched with reference to characteristics of an individual program segment.

### BACKGROUND OF THE INVENTION

1. Field of the Invention

Embodiments of the invention relate to providing information about television programs to television viewers, and more particularly to interactive program guides, interactive program banners, and related features.

2. Background Technology

In the era of broadcast television and analog cable television, viewers used printed listings to find the times and channels of television programs. Later, cable system operators began to provide channels dedicated to showing program listings. These listings were conventionally referred to as electronic program guides or EPGs. EPGs were typically presented as a passively scrolling grid in which each row showed the current and upcoming programs available on a particular channel. The scrolling grid was generated by a computer program using program guide data supplied by one of a handful of sources such as Tribune Media or TV Guide. While this type of program guide was useful it also had many shortcomings. For example, a viewer who wished to see the listings for a particular channel might be forced to wait several minutes while the guide slowly scrolled through other channels before arriving at the channel of interest. Further, the guide only displayed listings for a narrow window of time, typically 90 minutes, and so a viewer was unable to see listings for a later part of the day.

Subscribers to newer digital television services such as digital cable and satellite television use digital video receiver devices with data processing and storage capabilities. The processing capabilities of these devices has enabled the deployment of enhanced program guide technologies commonly referred to as interactive program guides or IPGs. IPGs present a graphical user interface that the viewer uses to actively navigate through a database of program listings. FIG. 1 shows an example of a conventional interactive program guide. The guide 12 is displayed in the viewing area 10 of a video display device such as a television in response to a display command from a remote control. The guide 12 is typically comprised of a grid 14 in which individual programs 16 are listed by channel 18 and time 20. The user may navigate through the programs in the grid using the keys of the remote control. This typically involves directing the movement of a cursor that highlights the field of the particular program on which it is located (e.g. the program “Business Day” in FIG. 1). By moving the cursor up and down the viewer may scroll through the channels listed in the grid. The guide typically scrolls by a row or a page when the user attempts to go past the top or bottom of the displayed rows, and most guides provide page up and page down functions, operated for example by pressing the channel up or channel down key on the remote control. Similarly, by moving the cursor to the right, the viewer may scroll forward in time to view future program listings. The guide typically shifts by one column or one page when the user attempts to go past the right-most column, and most guides provide page right and page left functions, operated for example by pressing fast forward and rewind keys or other designated keys on the remote control. Some guides also enable the user to scroll backward to listings for programs that have already aired.

When the viewer locates the cursor on the field of a particular program, information about that program is displayed in a program window portion 22 of the guide. This information typically includes the title of the program 24 and a description of the program 26.

The guide may also enable the viewer to take a number of actions with respect to a particular program. For example, the viewer may tune directly to a current program by navigating the cursor to that program and then pressing a select key on the remote control, and may record a current program by navigating the cursor to that program and then pressing a record key. Similarly, for a future program, the viewer may directly schedule actions from the guide such as recording of the program or generation of a reminder when the program is about to air. The guide may also enable the user to update viewing preferences stored in a viewer profile by indicating that the viewer is interested or disinterested in programs having characteristics similar to those of a program currently highlighted in the guide. Actions such as scheduling and indication of viewer preferences are usually performed using dedicated keys of a remote control.

Interactive program guides also typically provide various customization functions. For example, the specific channels displayed by the guide may be customized from a list of all possible channels. The guide may also be filtered to display only those programs having specified characteristics, such as a specified genre (e.g. sports, news, movie), rating (e.g. children, mature) or other feature such as the availability of closed caption data or alternate language audio.

Another type of interactive feature typically provided by digital video receiver devices is an interactive program banner. FIG. 2 shows an example of a conventional interactive program banner. The banner 28 is typically displayed over the image of the program currently being viewed, and typically includes information about the program including the name and time 30 of the program being viewed and descriptive information 32 about the program being viewed. The program banner is typically displayed upon changing the channel, and may also be displayed in response to user operation of an information key or other key on the remote control.

An example of the type of data used to generate conventional interactive program guides and program banners is illustrated in FIG. 3. This data, referred to herein as program metadata, provides information concerning various aspects of the program, such as a program identifier, the program title, program type, program genre, a description of the program series, a description of the subject matter of the particular episode, the channel, time and duration of the program, a program content rating, and other information such as language, alternate audio, closed caption, and audio type. In some instances additional data may be included such as keywords that are descriptive of the program subject matter.

What is notable about the conventional program metadata for purposes of this disclosure is that it treats the whole program as the fundamental unit of programming content. Although the program metadata may include a subject matter description that mentions different subjects addressed by the program, this description and the time and duration data correspond to the program as a whole, rather than to individual segments within the program. For example, referring to FIGS. 1 and 2, it is seen that the guide and banner provide description that indicates that the program “Business Day” includes content relating to “CEO Jeffrey Jones” and to the travel industry, but from this the viewer cannot know, for example, the specific times at which these segments are presented, or whether a particular segment is upcoming or has already been show.

Television programming distributors must attract viewers in order to sustain their advertising rates, and significant resources are invested in producing and obtaining the right programming content to attract the right viewers. However, as the amount of content grows, viewers are often presented with many concurrent attractive viewing options. The granularity provided by conventional interactive program guides and interactive program banners is coarse, owing to the coarseness of the data from which they are generated. This makes the most desirable content difficult to locate and places limitations on the viewer's ability to access all desirable content. For example, a viewer who sees a subject of interest in the description of a program cannot determine where in the program that subject is addressed, or whether it has already passed or is about to start soon. Similarly, a viewer may see two programs in the same time slot that are both of interest, but because he does not know when the particular segments of interest will be presented, the viewer may be forced to change back and forth between channels in an attempt to catch both, and may miss one or both in the process. Or the viewer may simply choose one program and forego the other. Similar limitations are imposed with respect to the other features typically provided by interactive program guides. A viewer may see the description of a program and decide, for example, that he would like to schedule a reminder for the program because he is interested in one of the topics that the program addresses. However, a reminder coinciding with the beginning of the program may be of little use if the segment that the viewer is interested in will not be presented until some unknown time later in the program. Similarly, the viewer may see two programs in the same time slot, each covering a topic that would both be desirable to record. However, if the user is limited to making only a single recording at any given time and can only schedule the recording of whole programs, then one program must be chosen over the other, even if the particular portions of interest are presented at non-overlapping times. Thus both the viewer and the programming distributor are denied an optimal viewing experience.

### SUMMARY OF THE INVENTION

Embodiments of the invention provide enhanced interactive program guides, interactive program banners and related features through the use of individual program segment metadata that provides descriptive and timing information for individual segments of television programs. Such program guides and program banners can provide detailed information to the viewer about individual program segments, such as descriptions of individual segments, the time and duration of individual segments, and the location of individual segments within the program. The display format of this information and the user interaction that produces the display of this information may be implemented in a variety of manners.

The program guides and program banners may also perform a variety of actions with respect to individual program segments, such as tuning directly to a program segment from a program segment listing in the guide, scheduling of reminders for an individual program segment from its listing in a guide or banner, initiating or scheduling the recording of an individual program segment directly from its listing in a guide or banner, filtering of the program guide on an individual segment basis, finding programs and program segments like a given program or segment through reference to the characteristics of the given program or segment, and updating viewer preferences through reference to the characteristics of a given program or program segment. The program guides and program banners may also include viewer interest level information indicating a level of viewer interest in programs and individual program segments determined using the program and segment metadata and stored viewer preferences. Viewing habits may also be tracked on an individual program segment basis.

### DESCRIPTION OF THE DRAWINGS

FIG. 1 shows features of a conventional interactive program guide;

FIG. 2 shows features of a conventional interactive program banner;

FIG. 3 shows an example of conventional television program metadata;

FIG. 4 shows an example of program and program segment metadata in accordance with an embodiment of the invention;

FIG. 5 shows an exemplary configuration of a metadata creation and distribution system;

FIG. 6 shows an exemplary architecture of a video receiver device in accordance with a preferred embodiment of the invention;

FIGS. 7a and 7b show typical user commands for an interactive program guide and actions taken by a video receiver device in response to those commands in accordance with an embodiment of the invention;

FIGS. 8a and 8b show features of an interactive program guide in accordance with a first embodiment of the invention;

FIGS. 9a and 9b show features of an interactive program guide in accordance with a second embodiment of the invention;

FIGS. 10a and 10b show features of an interactive program guide in accordance with a third embodiment of the invention;

FIGS. 11a and 11b show features of an interactive program guide in accordance with a fourth embodiment of the invention;

FIGS. 12a and 12b show typical user commands for an interactive program banner and actions taken by a video receiver device in response to those commands in accordance with an embodiment of the invention;

FIGS. 13a and 13b show features of an interactive program banner in accordance with a fifth embodiment of the invention;

FIGS. 14a and 14b show features of an interactive program banner in accordance with a sixth embodiment of the invention;

FIGS. 15a and 15b show features of an interactive progress bar in accordance with a seventh embodiment of the invention;

FIGS. 16a and 16b show features of an interactive program banner in accordance with an eighth embodiment of the invention;

FIGS. 17a and 17b show features of an interactive program guide in accordance with a ninth embodiment of the invention;

FIG. 18 shows features of an interactive program banner in accordance with a tenth embodiment of the invention;

FIG. 19 shows features of a user interface for providing an advanced find feature; and

FIGS. 20a and 20b show features of user interfaces for providing an advanced viewer preference update feature.

### DETAILED DESCRIPTION OF PREFERRED EMBODIMENTS

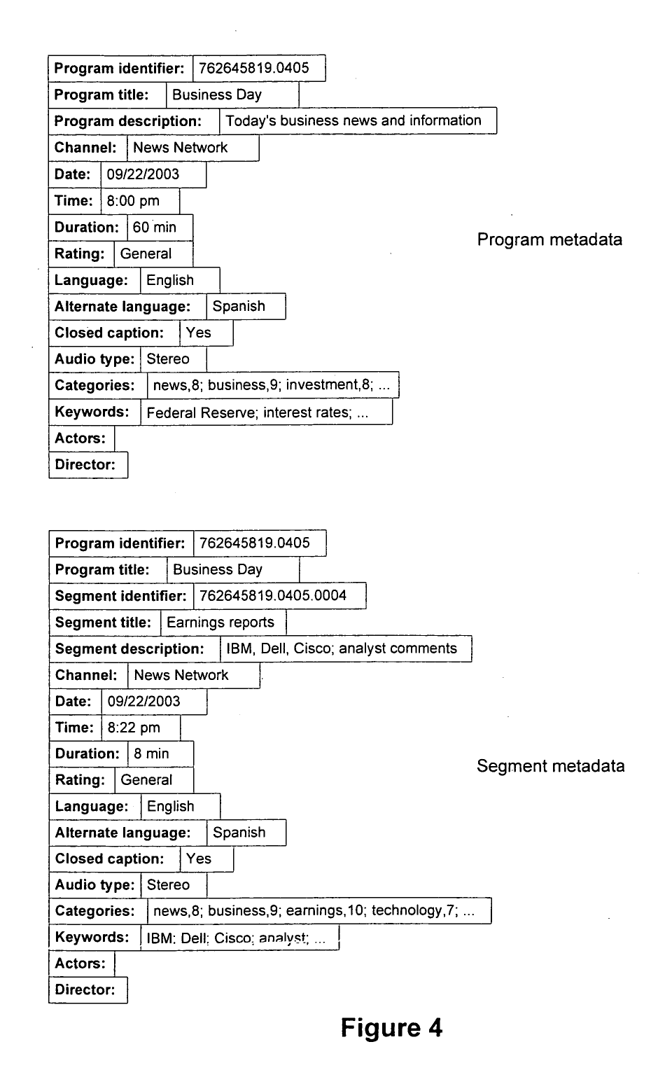

For purposes of this disclosure, the terms “segment metadata” and “program segment metadata” refer to data that includes description of the content of an individual segment of a television program, such as a segment identifier, title, content summary, categories, keywords, and that further includes timing information for the segment such as a start time, end time, start time and duration, reference to video frames. FIG. 4 shows examples of program metadata and segment metadata in accordance with an embodiment of the invention. The program metadata includes a variety of descriptive information concerning a television program, including the program title, a program description, and categories and keywords that are descriptive of the subject matter of the program, and actors and directors associated with the program. It is preferred that each category is provided with a corresponding score indicating the goodness of fit of the category to the subject matter of the program. The illustrated program metadata further includes timing information such as the start time and duration of the program. Other program information typically included in the program metadata such as a unique program identifier is also illustrated.

The segment metadata of FIG. 4 is similar to the program metadata, but is distinguished from the program metadata in that it provides content and timing information that is specific to an individual segment of a program rather than to the program as a whole. The illustrated segment metadata includes descriptive information including a segment title, a segment description, categories and keywords that are descriptive of the subject matter of the segment, and actors and directors associated with the segment. The illustrated segment metadata further includes timing information such as the start time and duration of the segment. Other segment information typically included in the segment metadata such as a unique segment identifier is also illustrated.

In the preferred embodiment, program metadata and segment metadata are distinct data objects that have logical relationships through the particular data that they contain. For example, the segment metadata of FIG. 4 is related to the program data of FIG. 4 in that they both reference the same program identifier, program title, channel, and date, and the time of the segment is within the time of the program. Thus it is known that the segment metadata of FIG. 4 describes a segment of the program described by the program metadata of FIG. 4. However in alternative implementations other methods may be used to specify relationships between program metadata and segment metadata objects, or metadata objects may be allowed to contain both program metadata and segment metadata.

Further details regarding the generation and use of program and segment metadata as described above are provided in patent applications owned by the assignee of the present application, including published application US 2002/0092002, published 11 Jun. 2002, which is incorporated herein by reference for its teachings regarding the generation and use of program and segment metadata and for its other teachings referenced herein.

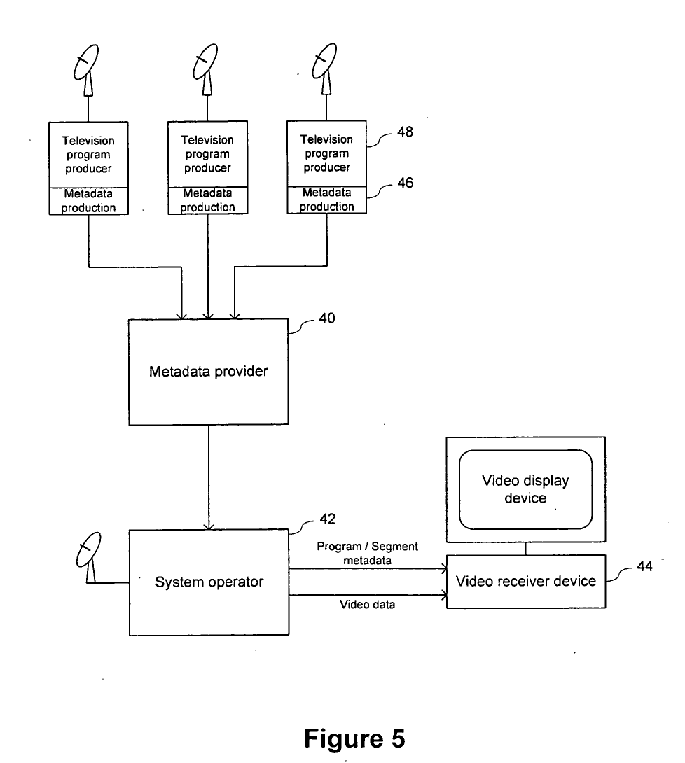

FIG. 5 shows an exemplary system for supplying program and segment metadata to a viewer's video receiver device. Program and segment metadata are preferably supplied by a metadata provider 40 to a system operator 42 such as a cable system operator or satellite television provider. The system operator 42 in turn supplies the metadata to individual video receiver devices 44 such as set top boxes and personal video recorders. In the case of cable and satellite systems, the metadata is typically supplied through the video data transmission medium as out-of-band data, that is, through a channel designated for transmission of non-video data. In other embodiments the video receiver device may obtain metadata in other manners such as through a dial-up or network connection to the metadata supplier.

The segment metadata supplied by the metadata supplier is preferably produced through the use of production agents 46 that interface directly with the production systems of television program producers 48 to extract production data that is processed to generate program metadata for the programs and to identify individual program segments and generate segment metadata for those segments. A preferred system for producing segment metadata in this manner is MyDTV Inc.'s ContentIQ metadata production system, aspects of which are described in the patent application incorporated above. This type of deployment enables production of detailed program and segment metadata in a highly automated fashion, and enables the production and distribution of detailed program metadata and segment metadata even for programs whose contents are typically not known until shortly before or at the time of broadcast, such as news programs and sporting events. However, alternative methods of metadata production and distribution may also be employed. For example, metadata may be distributed from the metadata provider to user devices through a system other than the video distribution system.

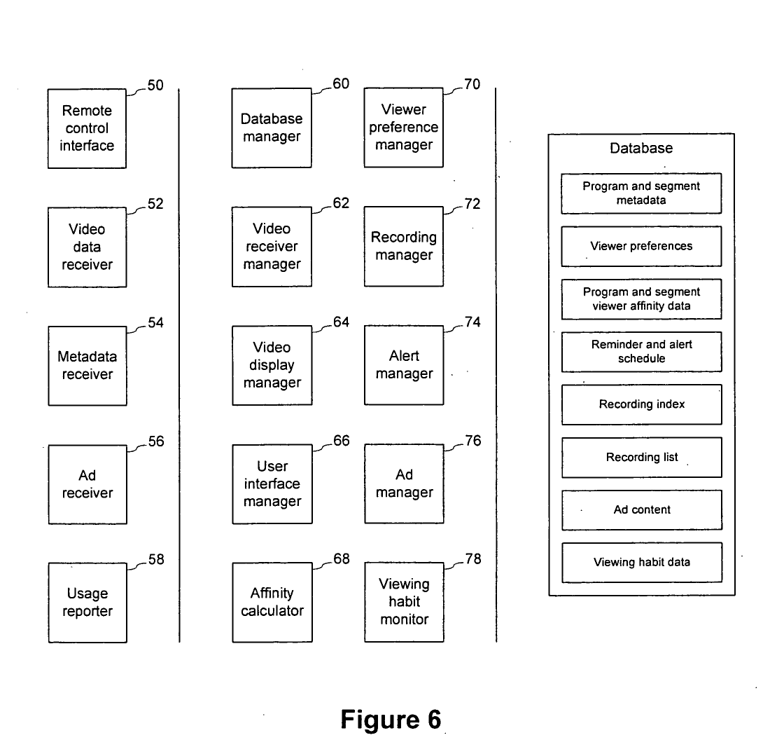

FIG. 6 shows a high level view of the architecture of a video receiver device in accordance with an embodiment of the invention. The illustrated components are typically implemented through a combination of software processes and hardware that runs or is controlled by the software processes. These components interact to provide program guide and program banner features such as those of the embodiments described below. The architecture illustrated in FIG. 6 is characteristic of a personal video recorder that provides video recording and playback features, however other architectures may be implemented on alternative platforms such as personal computers and home media servers, as well as on set top boxes, televisions, and other devices that do not provide recording functions. The differences in the components required for different implementations will be apparent. In general, the devices in which embodiments of the invention are implemented are programmable devices that include a microprocessor, nonvolatile memory storing programming code for controlling the microprocessor and other hardware, rewritable nonvolatile memory such as flash memory for storing configuration data, random access memory for providing a working memory space, a video decoder, a digital signal processor, and one or more communication interfaces for receiving data or signals from, supplying data or signals to or exchanging data or signals with various external systems and devices.

The components of the video receiver device include components for interfacing with other devices and systems. One component is a remote control interface 50 that receives user-generated control signals. The control signals are typically transmitted by an infrared or RF remote control device, but may be transmitted by other types of devices and may be received through another type of interface such as a physical or wireless network interface. A video data receiver 52 receives video data from the system operator, and a metadata receiver 54 receives metadata. An ad receiver 56 receives data for advertisements and promotional material that may be displayed by the device, such as in program guides and program banners. A usage reporter 58 reports usage data such as viewing habits, program purchases and other transactions. In some instances multiple interface components will utilize the same interface hardware.

The video receiver also includes a number of components for managing various aspects of the device to provide features as described herein. A database manager 60 manages the flow of data into and out of a database. The database contains a variety of data including program and segment metadata, viewer preference data, program and segment affinity data representing a calculated viewer affinity for programs and segments, a reminder and alert schedule, a recording schedule, an index of recorded content, ad content for display by the device to viewers, and viewing habit data representing viewers' viewing and recording choices.

A video receiver manager 62 controls the video receivers or tuners of the device to select a channel to be tuned to and demodulated for viewing or recording. A video display manager 64 selects video sources such as channels of live signals and previously recorded content as input to a video decoder to produce an output signal for a display device. A user interface manager 66 controls the appearance and operation of graphical user interfaces presented to the user such as program guides, program banners and other user interfaces, examples of which are described below. An affinity calculator 68 calculates a level of viewer affinity for programs, segments and ads based on viewer preferences defined by the viewer and metadata describing the programs, segments and ads. A viewer preference manager 70 receives input that defines the viewer's content preferences and maintains a viewer profile based on such input. The input may be direct viewer input or indirect viewer input such as viewing and recording habits. A recording manager 72 controls the scheduling and recording of video programs and program segments in response to automated and manual recording selections, and an alert manager 74 controls the viewer scheduling of reminders and the automated scheduling of alerts for programs and segments of interest to the viewer. Details concerning the creation of viewer profiles, their use in determining the viewer's affinity for particular content using program and segment metadata, and the automated scheduling of recordings and alerts based on those affinity levels are provided in the patent application incorporated above.

The receiver device components further include an ad manager 76 that controls the receipt of locally displayed advertisements and their selection for display in the program guide, in program banners, and at other times. The manner of ad selection may be arbitrary, may be based on relevance to a currently selected program or segment, or may be based on viewer affinity to the subject matter of the ad. In addition, a viewing habit monitor 78 generates and stores data indicating the viewing and recording habits of users of the device. This data may be used for purposes of updating viewer preferences and may be exported as usage data to services for establishing the size and composition of viewing audiences for programs and program segments.

The components shown in FIG. 6 interact to produce interactive program guides, interactive program banners and other features as described with respect to the following embodiments. The person of ordinary skill in the art will be capable of selecting hardware and producing programming code to implement the components of FIG. 6 or alternative components to produce the features of the following embodiments as well as various enhancements and alterations of those features that will become apparent from their description.

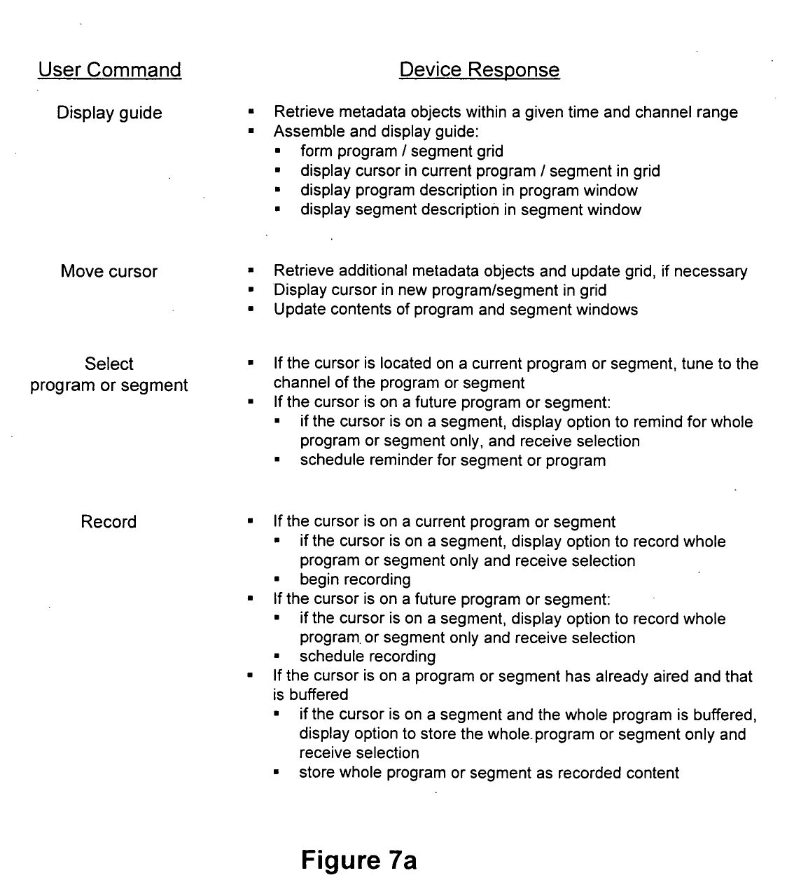

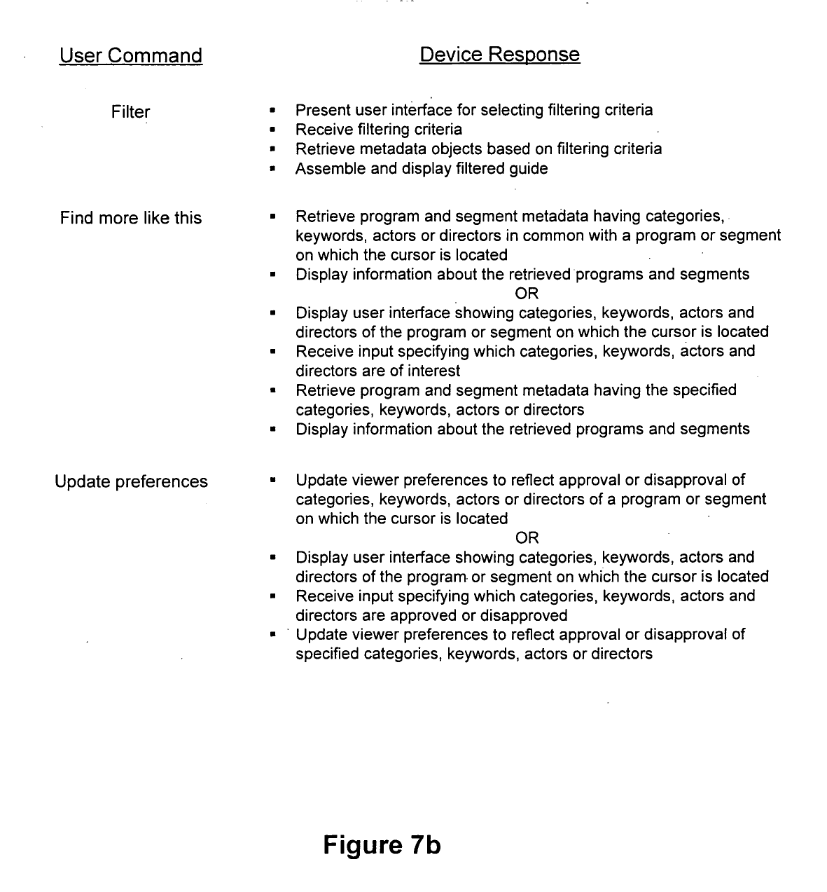

FIGS. 7a and 7b show a set of typical user commands supported by the interactive program guides illustrated below, and actions performed in response to those commands by the device that generates the program guides. A first user command is to display the program guide. This command is typically issued by pressing an information or display key on a remote control. Upon receiving this command, the device retrieves metadata objects corresponding to given time and channel parameters. These parameters are typically determined by the current time and the current channel to which the device is tuned, but the viewer may also be provided with the option of specifying times and channels. Based on the retrieved metadata objects, the guide is then assembled and displayed. Assembly and display of the guide may include forming a grid of fields for individual programs and program segments, displaying a cursor in the field of the current program or segment, displaying information for the program on which the cursor is located, and displaying information for the segment (if any) on which the cursor is located.

Another user command is to move the cursor. This command is typically issued by pressing arrow keys or page up or page down keys on the remote control. In response to this command, additional metadata objects are retrieved, if necessary, for example, when the cursor is moved to a time or channel not currently displayed in the grid. In such instances the grid is updated in accordance with the retrieved metadata objects. The cursor is then displayed in a field for a new program, and corresponding program and segment description information is displayed. If the program is a future program that includes individual segments, the cursor is typically placed on the first segment of the program.

Another user command is selection of a program or segment on which the cursor is located. This command is typically issued by pressing a select key on the remote control. The response to this command depends on several factors. If the selected program or segment is currently being presented, the selection is treated as a “tune-to” command, and the device responds by tuning to the corresponding channel of the program or segment. Alternatively, if the selected program or segment is a future program or segment, the command is treated as a command to schedule a reminder. If the selection is a program segment, the viewer is presented with the option of setting a reminder for the whole program or for the selected program segment. A reminder is then scheduled in accordance with the viewer's selection. It is noted that while the response to the select command outlined here presumes that a single selection command is used for both tuning and setting reminders, in alternative embodiments a dedicated reminder command may be defined separately from the select command.

Another user command is to record a segment or program on which the cursor is located. This command is typically issued by pressing a record key on the remote control. The response to this command depends on several factors. If the selected program or segment is currently being presented, the command causes recording to begin, and if the selection is a program segment, the viewer is first presented with the option of recording either the segment or the whole program. On the other hand, if the selected program or segment is a future program or segment, the command causes a recording to be scheduled. Again, if the selection is a program segment, the viewer is presented with the option of recording either the segment or the whole program. In addition, if the program or segment is a program or segment that has already aired or is currently airing, any buffered portion of the program may be stored as recorded content.

Another user command is to filter the guide. This command is typically issued by pressing a designated key on the remote control while the guide is being displayed. The device typically responds by presenting a user interface that allows the user to specify filtering criteria. The available filtering criteria may include any type of information included in the program and segment metadata objects in the database. Upon receiving input specifying filtering criteria, the device retrieves program and segment metadata objects based on the specified criteria, and assembles and displays the guide using the retrieved metadata objects.

Another user command is to find more programs and segments like a program or segment on which the cursor is located. This command is typically issued by pressing a designated key on the remote control while the guide is being displayed. The device may respond by providing an automatic search process or an advanced search process. In the automatic search process, the device automatically retrieves programs and segments having categories, keywords, actors and directors in common with the indicated program or segment. Typically the search is performed to identify programs and segments having any category, keyword, actor or director in common with the indicated program or segment, however alternative Boolean functions for the search may be predefined. Information is then displayed about the retrieved programs and segments. The information may be displayed in the program guide, or in an alternative manner such as a list. In the advanced search process, the device responds to the find command by displaying a user interface showing categories, keywords, actors and directors of the indicated program or segment, and receives input from the user indicating those particular categories, keywords, actors and/or directors that are desired to be matched in other programs and segments. The user may also be enabled to specify Boolean functions of those characteristics. The device then retrieves program and segment metadata based on the specified characteristics and displays information about the retrieved programs and segments in the program guide or in an alternative form such as a list. The device may be implemented with either or both of the automatic and advanced find features.

A further user command is to update viewer preferences to reflect an indicated preference for the characteristics of a program or segment on which the cursor is located. This command is typically issued by pressing a designated key on the remote control while the guide is being displayed. There may be separate designated keys for indicating approval and disapproval, respectively, or the user may be asked to specify whether approval or disapproval is being indicated. The device may respond by providing an automatic update process or an advanced update process. In the automatic update process, the device automatically updates viewer preferences with respect to categories, keywords, actors and directors listed in the metadata of the program or segment on which the cursor is located. The particular updating algorithm may be designed for the particular implementation. For example, the algorithm may add the keywords, actors and directors of the program or segment to the viewer profile, and increment the viewer preference score associated with each category of the program or segment by a fixed amount. Alternatively, the viewer preference scores associated with each category of the program or segment may be increased to a maximum amount. In other alternatives, the update algorithm may involve a thresholding procedure to select a subset of categories, keywords, actors and directors with which to update the viewer profile.

In the advanced update process, the device responds to the update command by displaying a user interface showing categories, keywords, actors and directors of the indicated program or segment, and receives input from the user indicating those particular categories, keywords, actors and/or directors are specifically approved of or disapproved of by the user. In the case of categories, the user may provide input indicating an amount of approval or disapproval, for example using a graphical tool such as a slide bar. The user interface may also allow the user to “qualify” a selected non-category characteristic to indicate that the non-category characteristic is of interest only when it is present in metadata that also contains a particular category. The device then updates the viewer profile by adding or removing any specified keywords, actors and directors, and changing the scores associated with specified categories, either by a predefined amount, or to scores indicated by the user. The device may be implemented with either or both of the automatic and advanced find features.

While the issuance of the aforementioned commands may be implemented using individual keys of a remote control for each command, they may also be implemented on a command menu that shows multiple commands and allows a user to select a desired command.

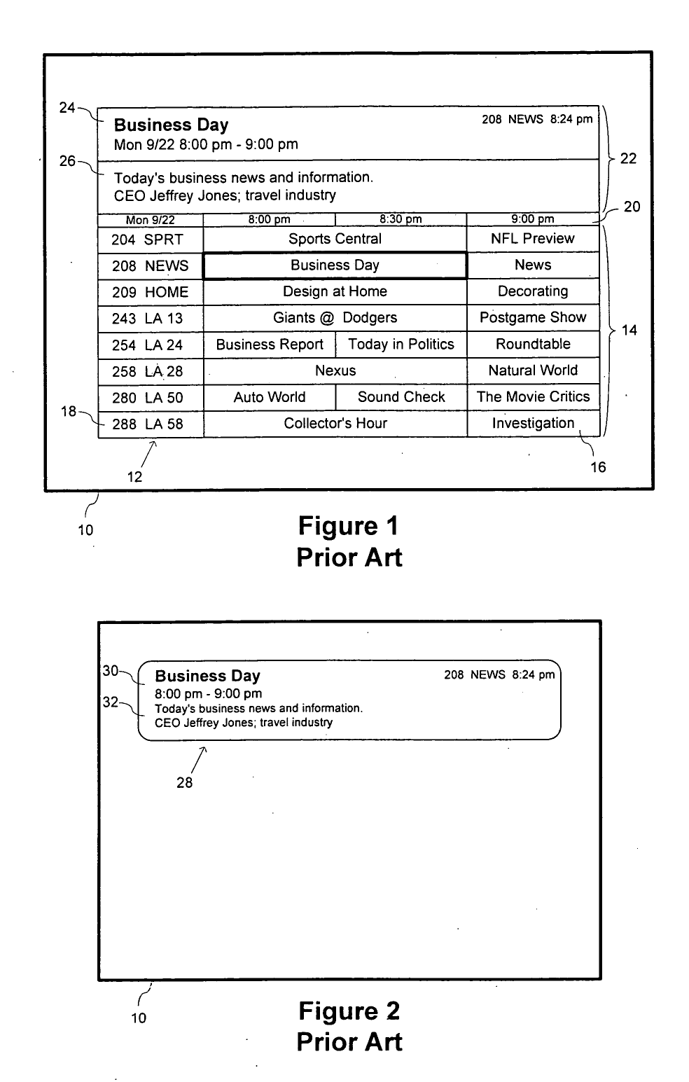

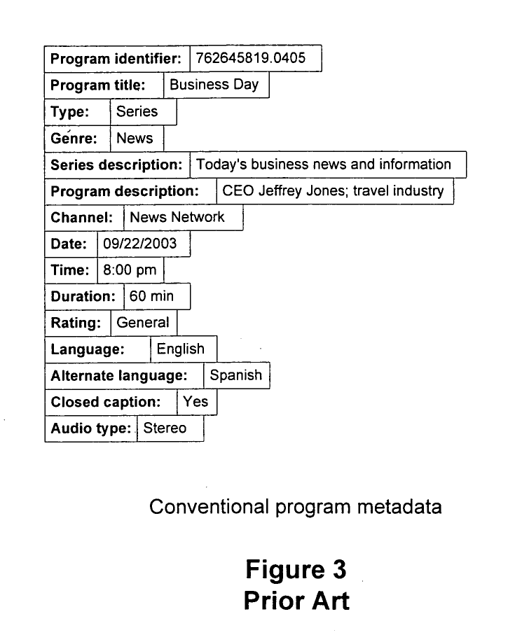

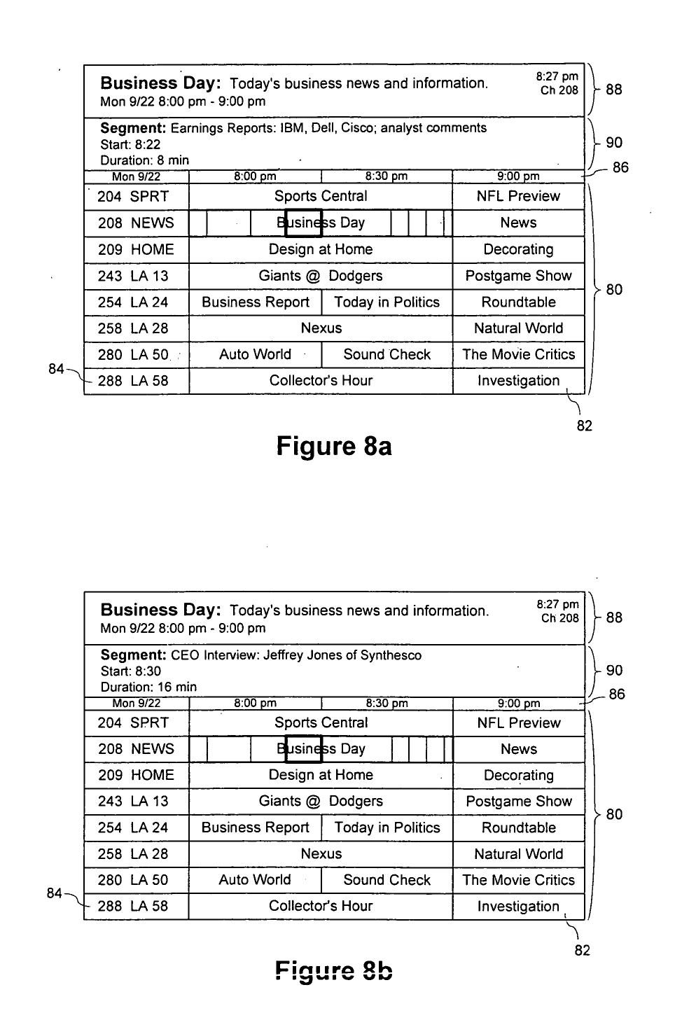

FIGS. 8a and 8b show an interactive program guide in accordance with a first embodiment of the invention. Like the conventional interactive program guide of FIG. 1, the guide of FIGS. 8a and 8b is arranged as a grid 80 in which individual programs 82 are listed by channel 84 and time 86. The guide further includes a program window 88 that displays information concerning the content, time and duration of a selected program. However, unlike the conventional guide, the guide of FIGS. 8a and 8b provides additional specific information about the content, time and duration of individual segments of programs for which individual segment metadata is available, and, if applicable, indicates the program segment that is currently being presented.

In particular, the program guide grid 80 includes individual fields corresponding to each segment of each program for which segment metadata is available. For example, in FIG. 8a, the entry for the program “Business Day” is subdivided into individual fields, each representing a distinct segment of the program. It is preferable that the sizes of the fields are proportional to the amounts of time between the beginnings of each segment. A current segment marker is preferably displayed to indicate the field of the segment that is currently being presented. In the guide of FIG. 8a, the current segment marker is provided as a distinct frame that surrounds the current segment. Additionally, as shown in FIG. 8a, when the cursor is moved to a current program for which segment metadata is available, the cursor is placed automatically in the segment that is currently being presented, coinciding with the placement of the current segment marker.

In addition, the program guide contains both a program information window 88 and a segment information window 90. The program information window 88 displays information about the program as a whole, such as a program title, description, time and duration. This information is typically obtained from the program metadata. The segment information window 90 displays information about the individual segment (if any) on which the cursor is located, such as a program title, description, start time and duration. This information is obtained from the segment metadata. As shown in FIG. 8b, movement of the cursor to the field of another segment within the same program causes the segment window 90 to be updated to display information about the new segment that the cursor is located on. Thus, by moving the cursor among the segment fields, the viewer can browse through descriptions of the individual segments of the program to determine whether particular segments are of interest, their locations within the program and the particular times at which they will be presented.

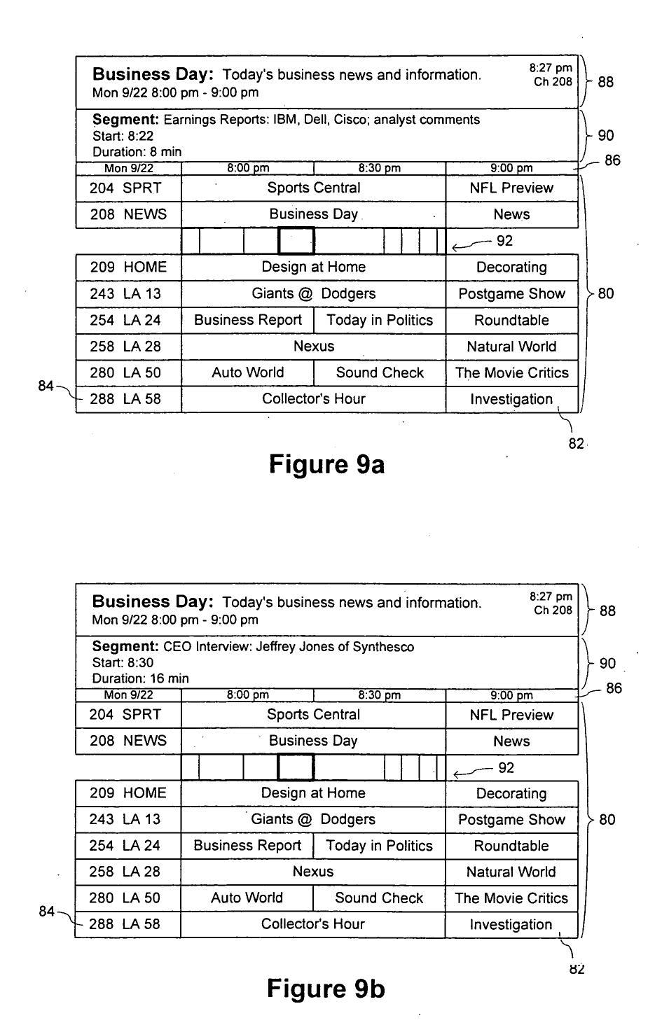

FIGS. 9a and 9b show a program guide in accordance with a second embodiment of the invention. This guide differs from the guide of FIGS. 8a and 8b in that programs having individual segments are represented by a full program field and by an array of individual segment fields located in the grid beneath the full program field. This type of presentation may be preferred because the demarcations of the individual segments do not obscure the program title in the program field. The array of segment fields may be displayed beneath the program field at all times, or may be displayed selectively when the cursor is moved onto the corresponding program field. In this embodiment, the cursor may be automatically moved to the segment field array 92 when the viewer navigates the cursor to the field of the corresponding program, allowing the viewer to then navigate the segment fields by moving the cursor left or right, and allowing the viewer to exit the segment fields and return to the grid by navigating past either end of the segment field array, or by moving the cursor up or down. As shown in FIG. 9b, the user may navigate through the segment fields to view corresponding segment information in the segment window 90.

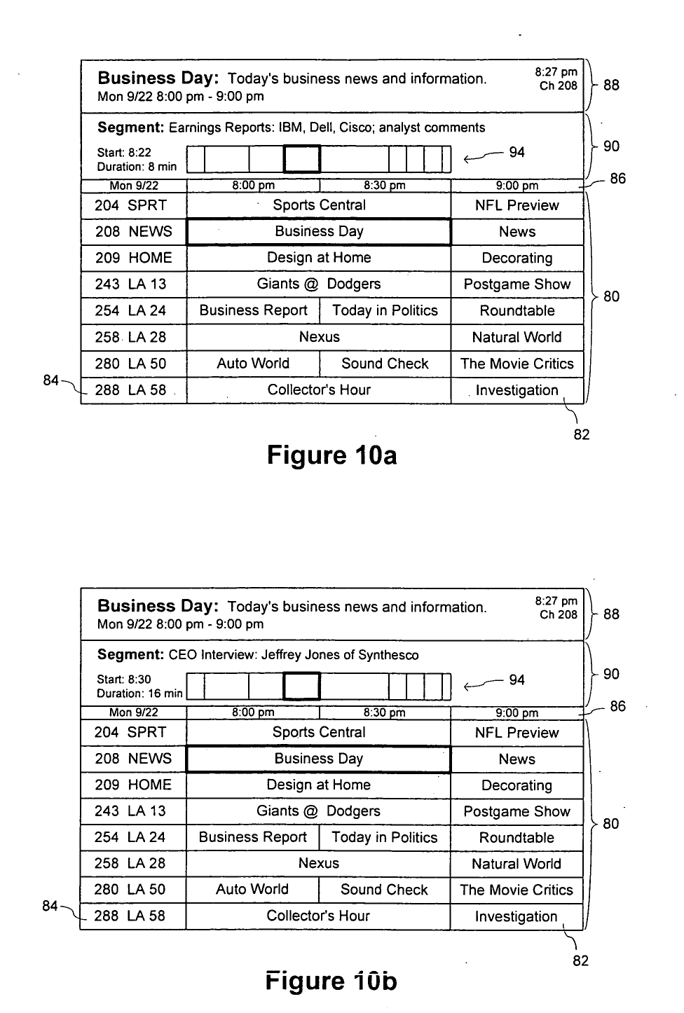

FIGS. 10a and 10b show a program guide in accordance with a third embodiment of the invention. This guide differs from the guide of FIGS. 8a and 8b in that an array of individual segment fields 94 is displayed in the segment window 90 when the cursor is moved onto the field of a program that has individual segments. Like the presentation of FIGS. 9a and 9b, this type of presentation may be preferred because the demarcations of the individual segment fields do not obscure the title in the field of the corresponding program. In this embodiment, the cursor may be automatically moved to the segment field array 94 in the segment window 90 when the viewer navigates the cursor onto the field of the corresponding program in the grid, allowing the viewer to then navigate the segment fields by moving the cursor left or right, and allowing the viewer to exit the segment fields and return to the grid by navigating past either end of the segment field array, or by moving the cursor up or down. As shown in FIG. 10b, navigation of the cursor through the segment fields produces the display of corresponding segment information in the segment window 90.

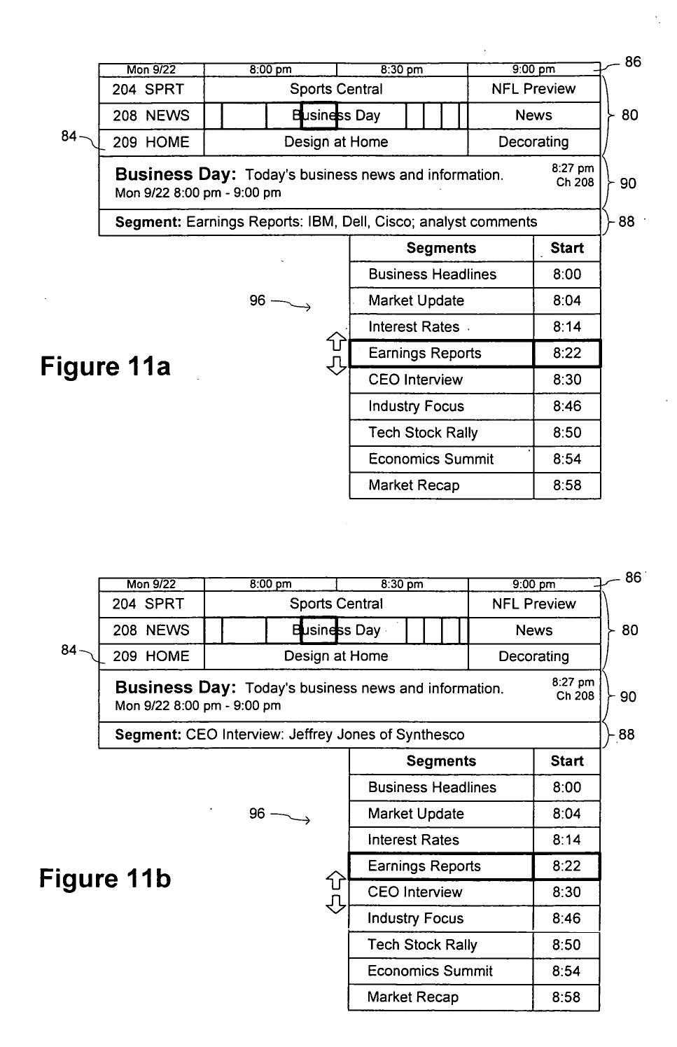

FIGS. 11a and 11b show a program guide in accordance with a fourth embodiment of the invention. This guide differs from the guide of FIGS. 8a and 8b in that a column 96 of segment fields is displayed when the viewer navigates to a program having individual segments. The segment fields in the column 96 display descriptive information for each segment and timing information for each segment such as the start time of each segment. In this embodiment, the cursor may be moved automatically to the segment field column 96 when the viewer navigates the cursor onto the field of the corresponding program in the grid, allowing the viewer to then navigate the segment fields by moving the cursor up or down, and allowing the viewer to exit the segment fields and return to the grid by navigating past either the top or bottom of the segment field column 96, or by moving the cursor left or right. As shown in FIG. 11b, user navigation through the segment fields produces the display of corresponding segment information in the segment window 90. In order to minimize the amount of space occupied by the column 96 of segment fields, it may be desirable to display a limited number of segment fields, and scroll the displayed fields in response to viewer navigation commands.

While the interactive program guides of FIGS. 8a-11b are currently preferred for the various reasons described above, it will be apparent that a variety of other alterations may be made while retaining the primary features of these embodiments. For example, while these embodiments display program and segment information in distinct “windows,” this manner of display is not critical, rather, it is important only to provide descriptive and timing information for individual segments in some portion of the guide. Further, while these embodiments generally display a detailed description for a single segment in response to movement of a cursor onto a field representing that segment, in other embodiments detailed information such as timing information or descriptive information may be provided for multiple segments or all segments upon, for example, moving a cursor onto a field representing the program. Further, other embodiments need not use the same navigation methods to enable display and navigation of individual segment descriptions. Additional graphical information may also be displayed in the guide, such as icons or symbols indicating the general subject matter of programs and segments. Such icons and symbols may be generated based on categories, keywords or other descriptive information in the program and segment metadata.

In addition, while these embodiments display program listings in the form of a grid covering multiple time slots, alternative embodiments may, for example, present a simple list of current programs, with associated display areas for displaying program and segment information for indicated programs and segments. Other embodiments may be implemented in which segment information is not automatically displayed in the guide. For example, rather than automatically showing navigable segment fields and segment descriptions in the guide, the guide may simply provide a visible indication of those programs for which segment information is available. Subsequently, in response to a user command, segment information or segment fields may be displayed for a program on which the cursor is located. Such information may be displayed within the guide, or may be displayed in a separate window that is presented in response to the user command. Further, the segment information may be navigable or passive, and may be formatted as segment fields or in another format, for example, as a simple list of segment descriptions and times.

Further, while the aforementioned embodiments assume an implementation in a conventional video reception system in which multiple video signals are continuously received and a chosen signal is tuned to, further embodiments the aforementioned program guides may be implemented in a video on demand system in which the selection of a program or segment in the program guide generates a demand for a particular program or segment, which is then supplied in response to the demand by a video server.

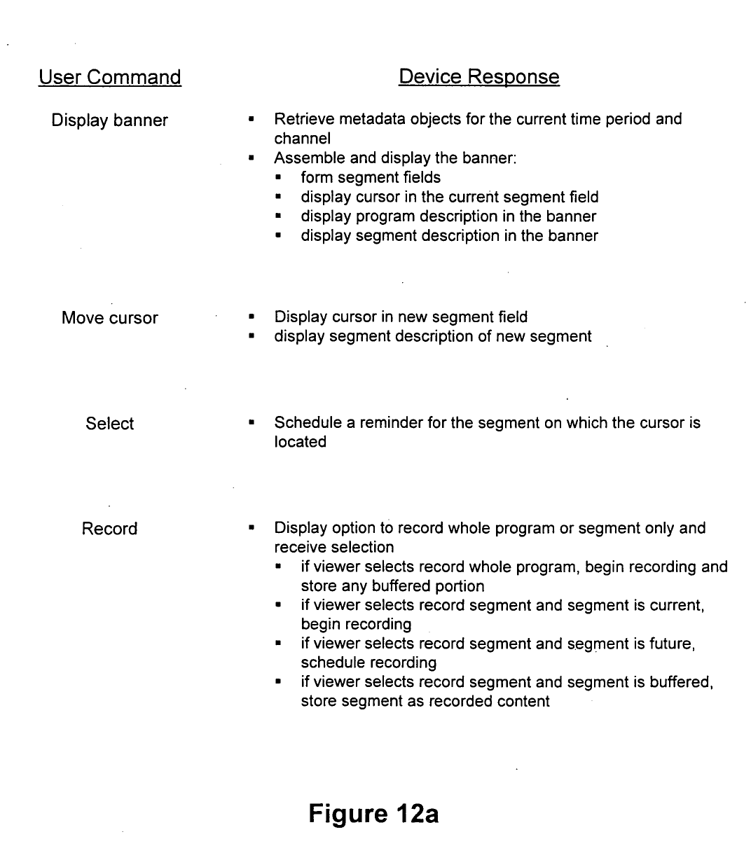

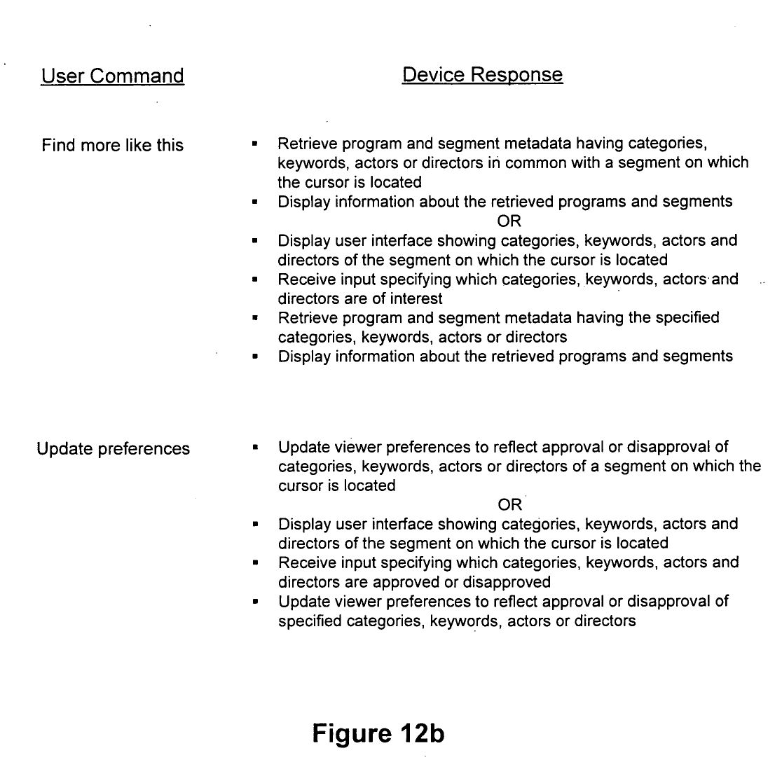

The next embodiments described herein relate to interactive program banners. These interactive program banners perform a variety of operations in response to various user commands. FIGS. 12a and 12b provide a summary of typical user commands and actions performed in response to those commands by the device providing the program banner in the embodiments illustrated below.

A first user command is to display the program banner. This command is typically issued by pressing a display or information key on a remote control. Upon receiving this command, the device retrieves metadata objects for the current time period and channel. Typically this involves retrieving the program metadata object for the current time and channel, and retrieving any segment metadata objects for the current channel within the time period defined in the program metadata object. Based on the retrieved metadata objects, the banner is then assembled and displayed. Assembly and display of the banner may include forming fields for individual segments of the program, displaying a cursor on the field of the current segment (if any), displaying a description of the program, and, if applicable, displaying a description of a segment on which the cursor is located.

Another user command is to move the cursor. This command is typically issued by pressing arrow keys of a remote control. In response to this command, the cursor is moved onto a new segment based on the direction of movement indicated by the received command, and the displayed segment information is updated to correspond to the segment on which the cursor is located.

Another user command is selection of a segment on which the cursor is located. This command is typically issued by pressing a select key on the remote control. Upon receiving this command, the device schedules a reminder if the cursor is located on an upcoming segment of the program.

Another user command is initiating or scheduling the recording of a highlighted segment or program. This command is typically issued by pressing a record key on the remote control. When the recording command is received, the viewer is presented with the option of recording either the individual segment on which the cursor is located, or the whole program. Upon receiving the user's response, recording begins or is scheduled, depending on whether the selected segment is currently being presented and whether the viewer has indicated that the whole program or only a segment is to be recorded. A past segment or portion of the program may also be stored as a recording if it has been buffered by the device.

Another user command is to find more programs and segments like a segment on which the cursor is located. This command is typically issued by pressing a designated key on the remote control while the banner is being displayed. The device may respond by providing an automatic search process or an advanced search process, similar to those discussed above with respect to the program guide commands and responses.

A further user command is to update viewer preferences to reflect an indicated preference for the characteristics of a segment on which the cursor is located. This command is typically issued by pressing a designated key on the remote control while the banner is being displayed. The device may respond by providing an automatic update or an advanced update process, similar to those discussed above with respect to the program guide commands and responses.

While the issuance of the aforementioned commands may be implemented using individual keys of a remote control for each command, they may also be implemented on a command menu that shows multiple commands and allows a user to select a desired command.

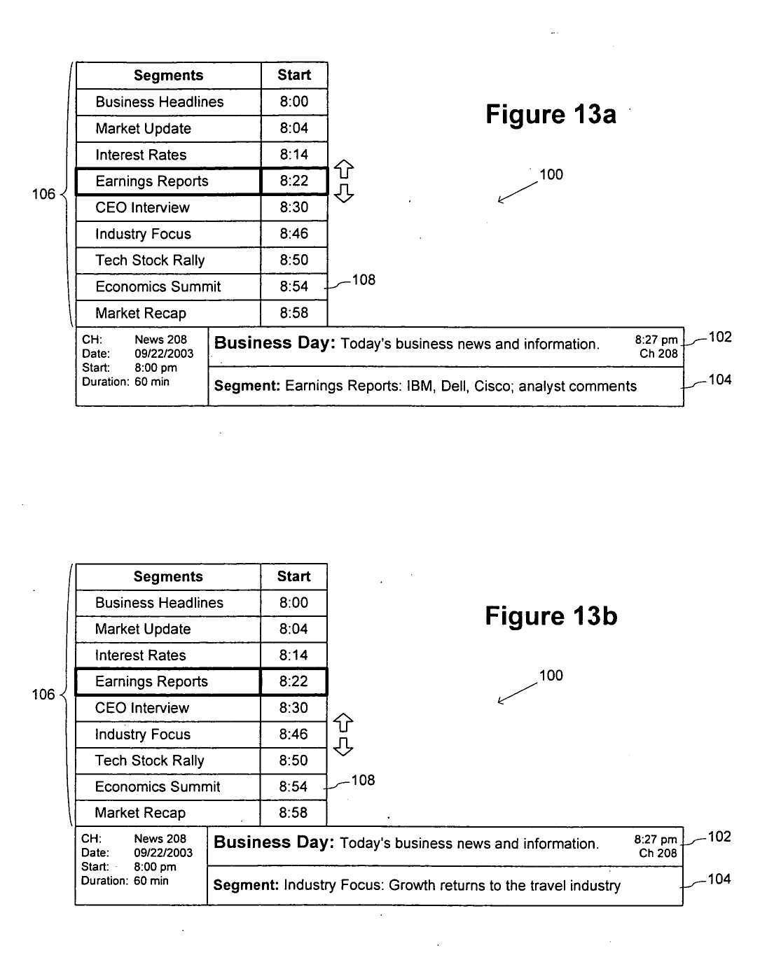

FIGS. 13a-13b show an interactive program banner in accordance with a fifth embodiment of the invention. Like the conventional program banner of FIG. 2, the program banner 100 of FIG. 13a includes a program window 102 that displays information concerning the content, time and duration of the current program, which is typically obtained from program metadata for the current program. However, the banner 100 also includes a segment window 104 that displays content information about a segment of the program, which is obtained from segment metadata for the segment on which the cursor is located. When the banner is initially displayed, the cursor is located on the field of the segment that is currently being presented.

The banner 100 also includes a column 106 of segment fields 108 that provide descriptive and timing information for segments of the program. When the banner is initially displayed a cursor is located in the segment field column 106 on the field of the current segment, and a current segment marker independent of the cursor is also preferably displayed. In the segment field column 106 of FIG. 13a the current segment marker is provided as a distinct frame that surrounds the field of the current segment, while the cursor is indicated by highlighting the segment field on which the cursor is located. As shown in FIG. 13b, the viewer may navigate the cursor up and down within the segment field column 106, causing the segment window 104 to display segment information for the segment on which the cursor is located.

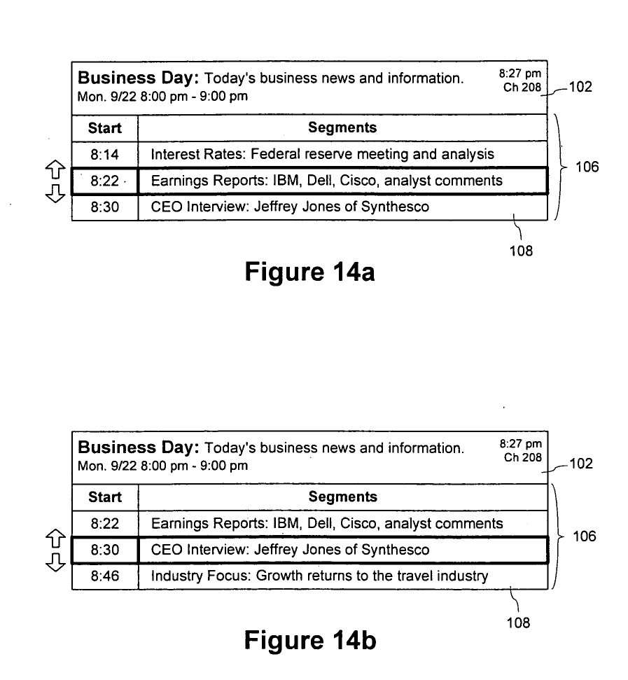

FIGS. 14a and 14b show an interactive program banner in accordance with a sixth embodiment of the invention. The program banner of FIG. 14a and 14b differs from the program banner of FIGS. 13a and 13b in that the segment fields 108 of the segment field column 106 contain detailed descriptive information that was displayed in the segment window of the previous embodiment. As shown in FIG. 14b, the viewer may scroll through the column of segment fields, with the current segment remaining highlighted. In the illustrated embodiment, the segment field column 106 contains a fixed number of segment fields 108, and the fields are scrolled in response to cursor movement commands. This embodiment may be preferred in order to reduce the amount of space occupied by the program banner while allowing the viewer to browse through information about each program segment using a display that provides information about several segments simultaneously.

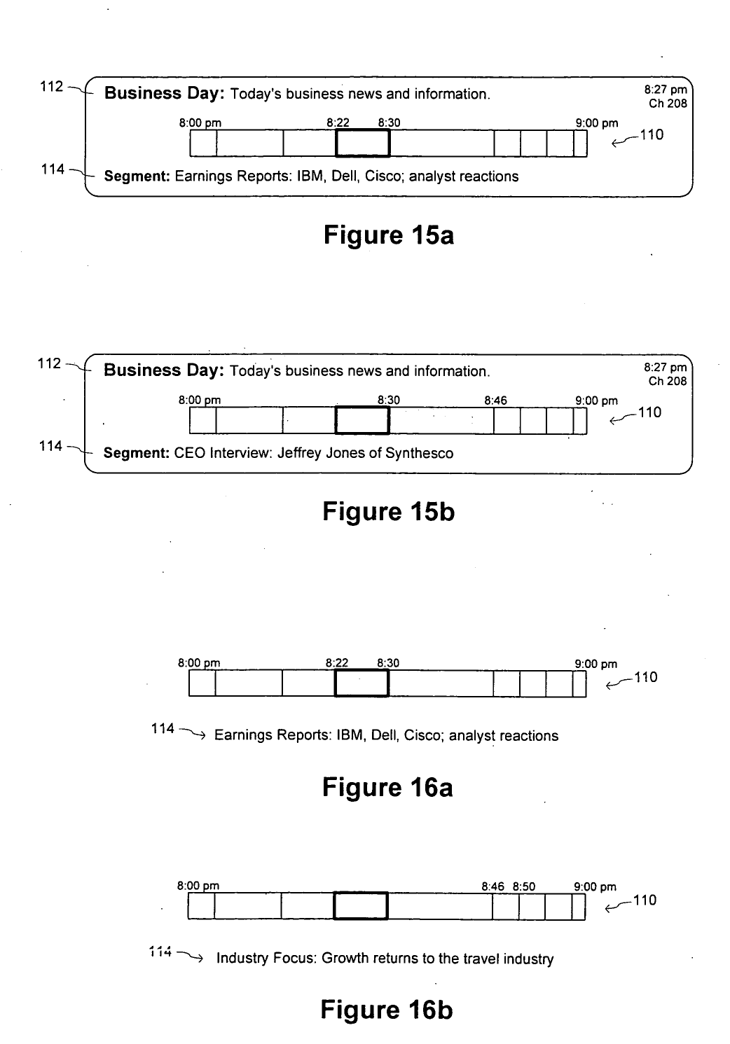

FIGS. 15a and 15b show an interactive program banner in accordance with a seventh embodiment of the invention. The program banner of FIGS. 15a and 15b uses an array of segment fields 110 to represent the segments of a program. The sizes of the respective segment fields are preferably proportional to the distances between their respective start times. The banner includes program description information 112 which is typically obtained from program metadata, and segment description information 114 which is obtained from segment metadata. When the program banner is initially displayed, the cursor is located in the field of the segment currently being presented, and above the cursor are provided the start time of the segment on which the cursor is located and the start time of the next segment. As shown in FIG. 15b, the cursor may be moved among the various fields of the segment field array 110, causing the segment information 114 to be updated to provide a description of the segment on which the cursor is located. This embodiment may be preferred for its reduced size.

FIGS. 16a and 16b show an interactive program banner in accordance with an eighth embodiment of the invention. The banner of this embodiment may also be referred to as a progress bar, and may be displayed in response to a banner display command or may be displayed independently in response to a different command. The banner or progress bar of FIGS. 16a and 16b includes an array of segment fields 110 that represent the segments of a program, with the sizes of the respective segment fields being proportional to the distances between their respective start times. The beginning and ending times of the program are indicated at the ends of the progress bar. The cursor is located on the field of the currently displayed segment and the beginning times of the present segment and the next segment are indicated above the cursor. Beneath the progress bar, descriptive information 114 about the current segment is provided. This data is obtained from the segment metadata. As shown in FIG. 16b, the cursor may be moved to the various fields of the segment field array 110, causing the segment information 114 to be updated to provide a description of the segment on which the cursor is located.

While the interactive program banners of FIGS. 13a-16b are currently preferred, it will be apparent that a variety of alterations may be made while retaining the primary features of these embodiments. For example, while some of these embodiments display program and segment information in distinct “windows,” this manner of display is not critical, rather, it is important only to provide descriptive and timing information for individual segments in some portion of the banner. Further, while some of these embodiments display a detailed description for a single segment in response to movement of a cursor onto a field representing that segment, in other embodiments detailed information such as timing information or descriptive information may be provided for multiple segments or all segments, for example, as a simple static or navigable list of segment descriptive and timing information. In addition, further embodiments may be implemented in which segment information is not automatically displayed in the banner. For example, rather than automatically showing navigable segment fields and segment descriptions in the banner, the banner may simply provide a visible indication when segment information is available for the program. Subsequently, in response to a user command, segment information or segment fields may be displayed. Such information may be displayed within the banner, or may be displayed in a separate window that is presented in response to the user command. Further, that segment information may be navigable or passive, and may be formatted as segment fields or in another format, for example, as a simple list of segment descriptions and times. Additional graphical information may also be displayed in the banner, such as icons or symbols indicating the general subject matter of programs and segments. Such icons and symbols may be generated based on categories, keywords or other descriptive information in the program and segment metadata. Further, the banner may simply be comprised of segment descriptive or timing information that is displayed in response to a display command.

While the program and segment information displayed in the foregoing embodiments generally includes only information that is contained in the segment metadata and program metadata, further embodiments may also display indications of the probable viewer interest in particular programs and segments generated by the affinity calculator or an analogous process using the program and segment metadata and viewer preference data. The generation of interest level data is preferably performed independently from user interface processing so that viewer interest level data may simply be retrieved from the database as needed. However, these embodiments may also be implemented such that viewer interest levels for particular programs and segments are calculated on an as needed basis.

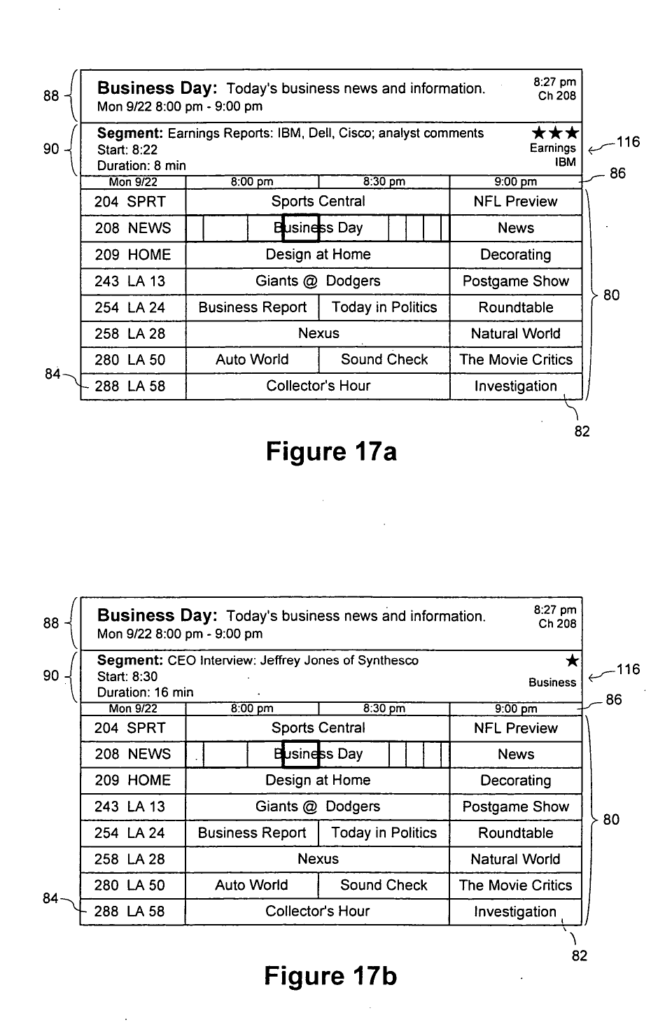

FIGS. 17a and 17b show an interactive program guide in accordance with a ninth embodiment of the invention. This embodiment provides an example of the inclusion of interest level data in the program guide. This embodiment differs from the embodiment of FIGS. 8a and 8b in that the segment window displays viewer interest level information 116 for the segment on which the cursor is located. The viewer interest level information 116 includes an indication of overall interest level based on the viewer's viewer profile data (represented as three stars to indicate high interest), a category from the viewer's viewer profile that contributed most significantly to the determination of the interest level (“Earnings”), and a keyword (if any) from the viewer's viewer profile that contributed most to the determination of the interest level (“IBM”). As shown in FIG. 17b, navigation of the cursor to a new segment produces a display of interest level information 116 for the new segment. Although not shown in FIGS. 17a and 17b, similar interest level information may be provided for whole programs as well as for program segments. Accordingly, the viewer may navigate among programs and program segments in the guide to view assessments of the likely level of interest in each program and segment. Similar information may be included in the various alternative program guides and program banners described herein.

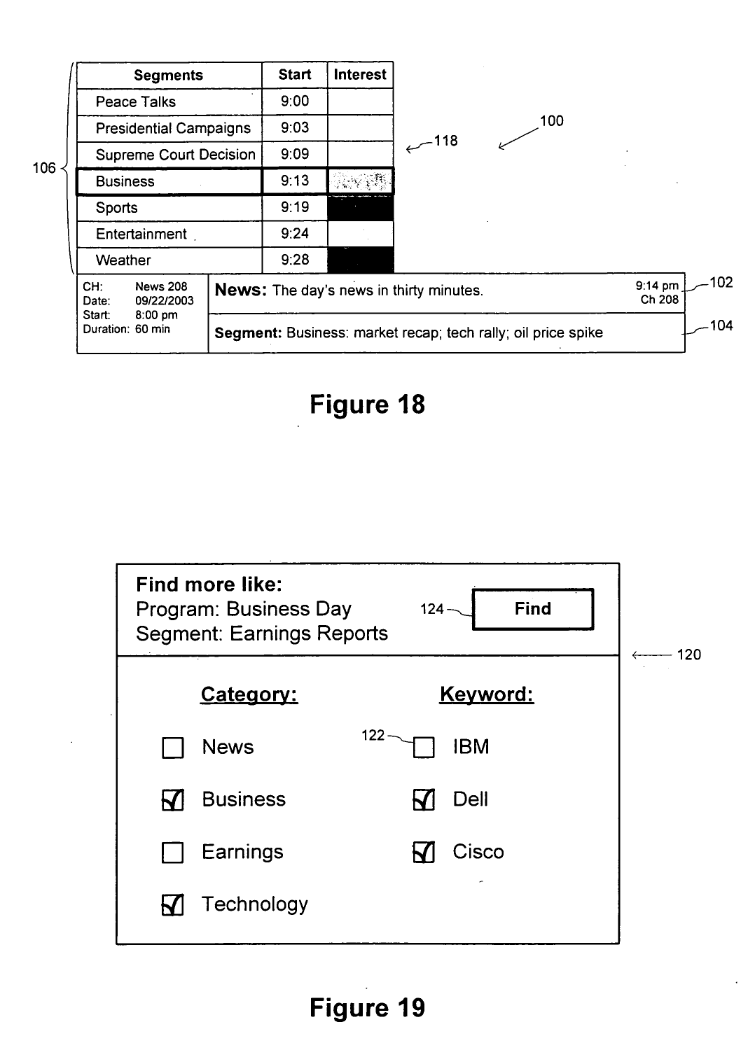

FIG. 18 shows an example of an interactive program banner in accordance with a tenth embodiment of the invention. This embodiment provides an example of the inclusion of interest level data in a program banner. This embodiment differs from the embodiment of FIGS. 13a and 13b in that the segment field column 106 includes an additional set of color coded interest level fields 118 that represent the interest level calculated for each segment. These fields enable the viewer to quickly determine which segments of the program are of particular interest and which are not. Similar fields may be incorporated into the program guide of FIGS. 11a-11b and the program banner of FIGS. 14a-14b.

Color coded interest level information may be incorporated into banners and guides in other manners as well. For example, segment fields themselves in a guide or banner may be colored to represent a viewer interest level. Program fields in a guide may also be colored in a similar manner. Color codes may also be associated with identifiers of programs and segments in other manners to indicate levels of interest. In addition, color coding may be used in combination with other representations of interest level such as those shown in FIGS. 17a-17b. These various representations of interest level may also be included in the various alternative program guides and program banners described herein.

The aforementioned program guide embodiments and program banner embodiments and alternative embodiments may be implemented with a find feature as discussed above. The find feature searches for upcoming programs and segments based on the characteristics of a program or segment on which the cursor is located in the guide or in a program banner. In alternative embodiments the find feature may also be accessed directly during viewing of a live or recorded program to find additional programs and segments like the currently viewed program or segment. As described above, the find process may be executed automatically in response to a find command based on features included in the metadata of a specified or currently viewed program or segment. Alternatively, an advanced find feature may be provided that enables the user to specify which categories, keywords, actors and directors are to be used in the search. FIG. 19 shows an example of a user interface generated for an advanced find feature in accordance with an eleventh embodiment of the invention. The user interface 120 displays all or a selected subset of the categories, keywords, actors and/or directors listed in the metadata for a program or segment. The example of FIG. 19 shows categories and keywords from the segment metadata illustrated in FIG. 4. The user interface also includes fields 122 that are navigable by the user, and that may be selected to indicate that the corresponding category, keyword, actor or director is to be used in searching for similar programs and segments. In the example of FIG. 19, the user has selected the categories “business” and “technology” and the keywords “Dell” and “Cisco” as search criteria. The user interface 120 further includes a find button 124 that can be navigated to and selected to initiate the search. The results of the search are then used to generate a display showing programs and segments matching the specified criteria. The display may be presented in the form of a navigable program grid, or may be provided in another form such as a searchable list.

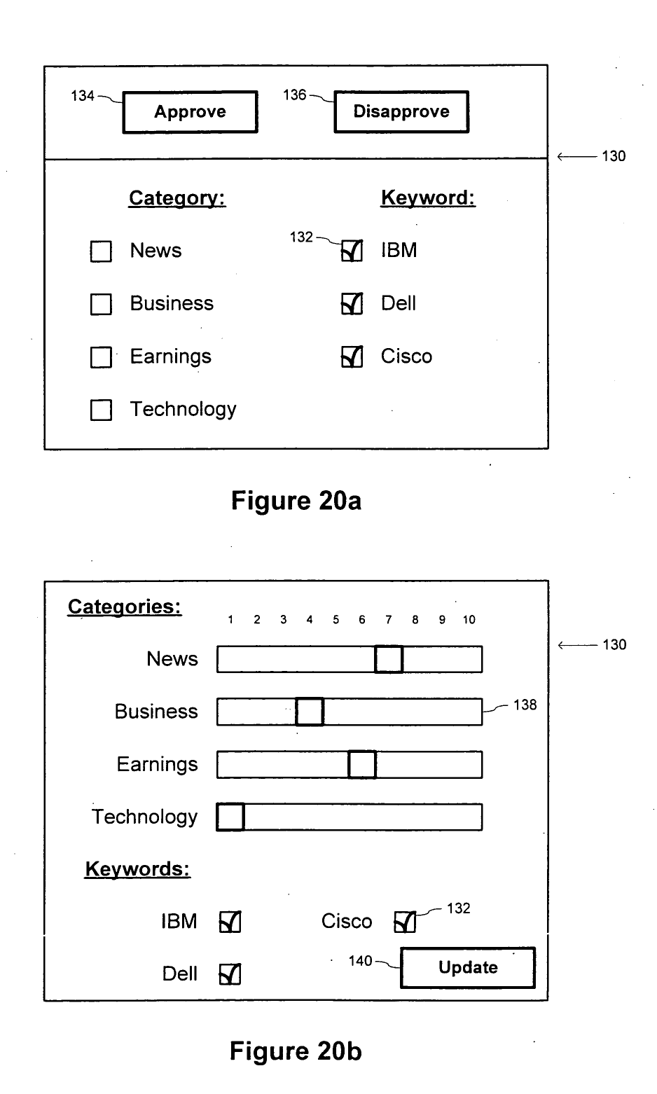

The aforementioned program guide embodiments and program banner embodiments and alternative embodiments may also be implemented with an update preferences feature as discussed above. The update preferences feature updates stored viewer preferences to indicate an approval or disapproval of subject matter like that of a program or segment on which the cursor is located in the guide or in a program banner. In alternative embodiments the update preferences feature may also be accessed directly during viewing of a live or recorded program to indicate a preference with respect to the currently viewed program or segment. As described above, the update preferences process may be executed automatically in response to an update command based on features included in the metadata of a specified or currently viewed program or segment. Alternatively, an advanced update feature may be provided that enables the user to specify which categories, keywords, actors and directors are to be used in updating the viewer profile. FIG. 20a shows an example of a user interface generated for an update preferences feature in accordance with a twelfth embodiment of the invention. The user interface 130 displays all or a selected subset of the categories, keywords, actors and/or directors listed in the metadata for a program or segment. The example of FIG. 20a shows categories and keywords from the segment metadata illustrated in FIG. 4. The user interface also includes fields 132 that are navigable by the user, and that may be selected to indicate that the corresponding category, keyword, actor or director is to be used in the update process. In the example of FIG. 20a, the user has selected the keywords “IBM,” “Dell” and “Cisco” as update criteria. The user interface 130 further includes approve 134 and disapprove 136 buttons that are used to initiate the updating of the viewer profile and to indicate whether the user approves or disapproves of the selected characteristics. This embodiment presumes that the update process is initiated by a single command that does not indicate approval or disapproval. In alternative embodiments, separate approve and disapprove commands may be provided for initiating the update process. This may be accomplished, for example, using separate approve and disapprove keys on a remote control. In such embodiments it is not necessary to provide the approve 134 and disapprove 136 buttons as in FIG. 20a. Rather, a single update button may be provided.

FIG. 20b shows an alternative user interface for an advanced update process in accordance with a thirteenth embodiment of the invention. This user interface differs from the user interface of FIG. 20a in that slide bars 138 are provided for indicating a particular score for each category or a selected subset of categories of the metadata of a program or segment. Each slide bar has a moveable field that may be navigated to and then moved left or right to indicate a preference score that the user wishes to associate with that category. An update button 140 is provided for initiating updating when category scores have been assigned and other characteristics have been selected.

As described above with respect to FIG. 6, embodiments in accordance with the invention may include a viewing habit monitor that tracks viewing of live television programs and segments, recording of programs and segments, and viewing of recorded programs and segments. Data representing these viewing habits may then be reported to an external system for use in various manners such as determining audience size and composition for programs and segments. The viewing habit data typically includes an identification of each program and segment that is actually received by the receiver device. These identifiers are obtained from the metadata applicable to the time periods in which the device is operated and the channels tuned to during those time periods. The viewing habit data may further indicate for each program and segment whether the program or segment was viewed as it aired or was recorded for later viewing. Data about viewing of recorded programs may also be compiled, such as whether the recorded program was viewed and when.

The embodiments described above do not explicitly address the presence of commercials that occur during or between program segments. The manner in which this issue is addressed may be determined based on the needs of the particular implementation. In the embodiments described herein, it is assumed that the segment metadata indicates, at a minimum, the start time of the segment, and that information concerning the location and length of commercials is not available. Under those circumstances, segments may, for example, be treated as encompassing all time between their indicated start time and the start time of the next successive segment, and time information presented to the user in the form of durations or segment field lengths may be determined accordingly. In other implementations there may be information indicating the location and length of commercials, or indicating the duration of segments excluding any commercials, and in those implementations other forms of presentation may be designed accordingly. Commercials or commercial breaks may also have their own segment metadata and may be made available or hidden for purposes of the various displays and actions described herein.

The embodiments described above also assume that the program guide or program banner is produced by a device such as a set top box or personal video recorder that is controlled by the viewer using a conventional infrared or RF remote control. However in other implementations the viewer control signals may be provided to the device in other manners. For example, the device may be networked to a personal computer or personal digital assistant, allowing commands to be entered using an interface generated by the computer.

The embodiments described above also assume that timing information in program and segment metadata is provided in the form of an absolute time of day. However, in the case of segment metadata, the timing data need not be represented in this manner, an instead could be represented, for example, as a time difference from the start time of the program.

The embodiments described above also refer to a cursor, which is implemented by highlighting the program or segment field on which the cursor is located. However, it will be appreciated that a cursor or other manner of visual indication may be implemented in a variety of ways. Such various options may be referred to generally as an indicator.

While the aforementioned embodiments are described as being implemented in a video receiver device such as a set top box, personal video recorder or home media server, further embodiments may be implemented on other platforms. For example, devices that typically do not receive multiple channels of video data, such as personal computers, personal digital assistants and cell phones, can be used as platforms for implementing many of the features described above. In one alternative embodiment, these and other platforms may support a program guide that displays information about programs and program segments, and that provides related features such as scheduling and generating reminders, finding similar programs and segments, and updating preferences based on the characteristics of a specified program or segment. Additional capabilities related to the receipt of video, such as recording and scheduling of recording, displaying banners over video content, and tuning to programs or requesting transmission of programs, may be implemented on such platforms to the extent that receipt of video signals is available.

The devices, features and processing described herein are not exclusive of other devices, features and processing, and variations and additions may be implemented in accordance with the particular objectives to be achieved. For example, a system as described above may be integrated with other systems not described herein to provide further combinations of features, to operate concurrently on the same computing devices, or to serve other types of users. Thus, while the embodiments illustrated in the figures and described above are presently preferred for various reasons as described herein, it should be understood that these embodiments are offered by way of example only. The invention is not limited to a particular embodiment, but extends to various modifications, combinations, and permutations that fall within the scope of the claims and their equivalents.

1. A programmable device comprising a computer readable medium storing programming code for controlling the device to perform processing comprising:
storing program metadata that includes timing and descriptive data for television programs and segment metadata that includes timing and descriptive data for individual segments of television programs;
receiving a command to display a program guide; and
in response to the command, producing from the program metadata and segment metadata a program guide, the program guide comprising a grid of fields representing television programs arranged by time and channel, the program guide further comprising fields representing individual segments of programs that are present in the grid.

2. The device claimed in claim 1, wherein the program guide further comprises an indicator that is navigable among said program and segment fields in response to navigation commands to indicate a particular program or segment.

3. The device claimed in claim 2, wherein the location of the indicator on a field representing a program segment causes display in the guide of descriptive information concerning that program segment.

4. The device claimed in claim 2, wherein said processing further comprises:
in response to a command, tuning to a channel of a segment indicated by the indicator.

5. The device claimed in claim 2, wherein said processing further comprises:
in response to a command, scheduling a reminder for a segment indicated by the indicator.

6. The device claimed in claim 2, wherein said processing further comprises:
in response to a command, scheduling the recording of a segment indicated by the indicator.

7. The device claimed in claim 2, wherein said processing further comprises:
in response to a command, initiating recording of a segment indicated by the indicator.

8. The device claimed in claim 2, wherein said processing further comprises:
in response to a command, updating viewer preferences stored by the device in accordance with segment characteristics represented in the segment metadata of a segment indicated by the indicator.

9. The device claimed in claim 2, wherein said processing further comprises:
in response to a command, presenting a user interface that displays segment characteristics represented in the segment metadata of a segment indicated by the indicator;
receiving user selections with respect to the displayed segment characteristics; and
updating viewer preferences in accordance with the user selections.

10. The device claimed in claim 2, wherein said processing further comprises:
in response to a command, identifying and displaying additional segments and programs having characteristics in common with characteristics represented in the segment metadata of a segment indicated by the indicator.

11. The device claimed in claim 2, wherein said processing further comprises:
in response to a command, presenting a user interface that displays segment characteristics represented in the segment metadata of a segment indicated by the indicator;
receiving user selections with respect to the displayed segment characteristics; and
identifying and displaying additional segments and programs having characteristics in common with the selected segment characteristics.

12. The device claimed in claim 2, wherein said processing further comprises:
in response to a command, issuing a request for transmission to the device of a segment indicated by the indicator.

13. The device claimed in claim 2, wherein the program guide further comprises interest level information indicating a level of viewer interest in a segment indicated by the indicator.

14. The device claimed in claim 13, wherein the interest level information includes a color code representing the level of viewer interest.

15. The device claimed in claim 13, wherein the interest level information includes at least one of a category and a keyword used in determining the interest level information.

16. The device claimed in claim 2, wherein the program guide further comprises interest level information indicating respective levels of viewer interest in respective segments of a program.

17. The device claimed in claim 16, wherein the interest level information includes a color code representing the level of viewer interest.

18. The device claimed in claim 16, wherein the interest level information includes at least one of a category and a keyword used in determining the level of interest.

19. The device claimed in claim 1, wherein the segment fields are located in the grid on the field of the program to which they correspond.

20. The device claimed in claim 19, wherein the locations of borders of the segment fields within the program field are proportioned according to start times of the respective segments.

21. The device claimed in claim 1, wherein the segment fields are located in the grid below the field of the program to which they correspond.

22. The device claimed in claim 1, wherein the segment fields are located outside of the grid.

23. The device claimed in claim 22, wherein the segment fields are located in a segment description display area of the guide.

24. The device claimed in claim 1, wherein the segment fields are arranged in a column outside of the grid.

25. The device claimed in claim 24, wherein the segment fields contain descriptive information and timing information for respective segments of a program.

26. The device claimed in claim 1, wherein metadata used to produce the guide is selected from among the stored program metadata and segment metadata in accordance with user-specified filtering criteria.

27. A method in a programmable device, comprising:
storing program metadata that includes timing and descriptive data for television programs and segment metadata that includes timing and descriptive data for individual segments of television programs;
receiving a command to display a program guide; and
in response to the command, producing from the program metadata and segment metadata a program guide, the program guide comprising a grid of fields representing television programs arranged by time and channel, the program guide further comprising fields representing individual segments of programs that are present in the grid.

28. A method in a programmable device comprising:
storing program metadata that includes timing and descriptive data for television programs and segment metadata that includes timing and descriptive data for individual segments of television programs; receiving a command to display a program guide;
in response to the command, producing from the program metadata a program guide, the program guide comprising a grid of fields representing television programs arranged by time and channel; and
in response to a further command, displaying segment information from said segment metadata for a program in said grid.

29. The device claimed in claim 28, wherein said grid comprises an indicator that is navigable by a user among said program fields, and
wherein said segment information is displayed for a program indicated by the indicator.

30. The device claimed in claim 29, wherein said segment information comprises segment fields navigable by said indicator.

31. The device claimed in claim 30, wherein said processing further comprises:
displaying additional segment information for a segment on which the indicator is located.

32. A method in a programmable device comprising:
storing program metadata that includes timing and descriptive data for television programs and segment metadata that includes timing and descriptive data for individual segments of television programs;
receiving a command to display a program guide;
in response to the command, producing from the program metadata and segment metadata a program guide, the program guide comprising fields representing television programs arranged by channel, the program guide further comprising fields representing individual segments of a program in the list for which segment metadata is available.

33. A method in a programmable device comprising:
storing program metadata that includes timing and descriptive data for television programs and segment metadata that includes timing and descriptive data for individual segments of television programs;
receiving a command to display a program guide;
in response to the command, producing from the program metadata and segment metadata a program guide, the program guide comprising fields representing television programs arranged by channel; and
in response to a further command, displaying segment information from said segment metadata for a program in the list.

34. A method in a programmable device comprising:
storing program metadata that includes timing and descriptive data for television programs and segment metadata that includes timing and descriptive data for individual segments of television programs;
receiving a command to display a program guide; and
in response to the command, presenting a program guide that is produced from the program metadata and segment metadata, the program guide comprising:
fields representing television programs; and
a portion that is customized to display information from the metadata of segments of programs displayed in the guide in response to navigation commands.
